(19) United States
(12) Patent Application Publication
(10) Pub. No.: US 2023/0331002 A1
(43) Pub. Date: Oct. 19, 2023

(54) PRINTING APPARATUS

(71) Applicant: SHOWA ALUMINUM CAN GLOBAL CORPORATION, Tokyo (JP)

(72) Inventor: Shinichi OJIMA, Bunkyo-ku, Tokyo (JP)

(73) Assignee: ALTEMIRA Co., Ltd., TOKYO (JP)

(21) Appl. No.: 18/025,392

(22) PCT Filed: Sep. 14, 2021
(86) PCT No.: PCT/JP2021/033710

§ 371 Date: Mar. 8, 2023

(30) Foreign Application Priority Data
Oct. 5, 2020 (JP) 2020-168704

(51) Int. Cl. B41J 11/00; B41J 3/407

(52) U.S. Cl. CPC B41J 11/00218; B41J 11/00214; B41J 3/40733; B41J 11/00212

(57) ABSTRACT

A printing apparatus is provided with: a printing unit disposed at a position facing an outer circumferential surface of a can body and performing printing on the outer circumferential surface of the rotating can body; and a curing unit disposed on a side opposite to a side on which the printing unit is installed across the can body, and curing a print image formed on the outer circumferential surface by the printing unit. The printing unit performs printing on the outer circumferential surface using an inkjet head, and the curing unit is disposed on a side opposite to a side on which the inkjet head is installed across the can body.

### TECHNICAL FIELD

The present invention relates to a printing apparatus.

### BACKGROUND ART

In Patent Document 1, there is disclosed a printing device including a mandrel wheel, plural automatically-rotatable mandrels provided to the mandrel wheel, and an inkjet printing station for forming a print image at least on the body part of the outer surface of the seamless can mounted on the mandrel by inkjet printing.

### CITATION LIST

### Patent Literature

Patent Document 1: Japanese Patent No. 5891602

### SUMMARY OF INVENTION

### Technical Problem

In a printing apparatus performing printing on can bodies, a printing unit that performs printing on can bodies, and a curing unit for curing images formed on the can bodies are provided in some cases.

The curing unit uses light, heat, etc. to cure the images, however, there is a risk of deteriorating the quality of the image formed due to action of the light or heat on the printing unit.

An object of the present invention is to suppress deterioration of quality of an image formed on a can body caused by a curing unit that cures the image formed on the can body.

### Solution to Problem

Under the above object, a printing apparatus to which the present invention is applied includes: a printing unit disposed at a position facing an outer circumferential surface of a can body to perform printing on the outer circumferential surface of the can body that is rotating; and a curing unit disposed on a side opposite to a side on which the printing unit is installed across the can body to cure a print image formed on the outer circumferential surface by the printing unit.

Here, the printing unit may perform printing on the outer circumferential surface using an inkjet head, and the curing unit may be disposed on a side opposite to a side on which the inkjet head is installed across the can body.

In addition, the printing unit may perform printing on the outer circumferential surface from above the can body, and the curing unit may perform curing of the print image from below the can body.

In addition, the printing unit may perform printing on the outer circumferential surface using photo-curable ink to form the print image, and the curing unit may irradiate the outer circumferential surface with light to cure the print image.

In addition, the curing unit may cure the print image formed on the outer circumferential surface by the printing unit using light or heat, and the printing apparatus may further includes a shielding member shielding the light or heat from the curing unit to the printing unit.

In addition, the shielding member may include a portion for passing light or heat from the curing unit to the outer circumferential surface.

In addition, the portion for passing may be configured with an opening or a cutout formed in the shielding member.

In addition, the printing unit may perform printing on the outer circumferential surface using photo-curable ink, and the curing unit may turn on a light source to irradiate the outer circumferential surface with light through the portion for passing, and may turn off the light source or may reduce output of the light source when the can body does not exist at a position facing the portion for passing.

In addition, plural shielding members may be provided, and a gap may be provided between one of the plural shielding members and another to allow the light or heat from the curing unit to head for the outer circumferential surface.

In addition, the printing unit may perform printing on the outer circumferential surface using photo-curable ink, and the curing unit may turn on a light source to irradiate the outer circumferential surface with light through the gap, and may turn off the light source or may reduce output of the light source when the can body does not exist at a position facing the gap.

In addition, the can body may be cylindrically formed and may have an axial center, and the shielding member may be disposed closer to the printing unit than a facing portion of the outer circumferential surface of the can body facing the curing unit, and may be disposed closer to the curing unit than an opposite portion of the outer circumferential surface located on a side opposite to the facing portion across the axial center.

From another standpoint, a printing apparatus to which the present invention is applied includes: a printing unit disposed at a position facing an outer circumferential surface of a can body to perform printing on the outer circumferential surface of the can body that is rotating; a curing unit disposed at a position facing the outer circumferential surface of the can body to cure a print image formed on the outer circumferential surface by the printing unit by using light or heat; and a shielding member shielding the light or heat from the curing unit to the printing unit.

Here, a mover unit that moves the shielding member may further be included.

In addition, at least two positions, which include a shielding position shielding the light or heat and located on a moving route of the can body, and an out-of-route position deviated from the moving route, may be set, and the mover unit may move the shielding member from one of the shielding position and the out-of-route position to the other, and may move the shielding member from the other to the one.

### Advantageous Effects of Invention

According to the present invention, it is possible to suppress deterioration of quality of the image formed on a can body caused by a curing unit that cures the image formed on the can body.

### BRIEF DESCRIPTION OF DRAWINGS

FIG. 1 is a side elevational view of a printing apparatus;

FIG. 2 is a diagram illustrating an inspection device;

FIGS. 3A and 3B are diagrams showing a structure of a portion where a fourth inkjet head is provided;

FIGS. 4A to 4C are diagrams showing another configuration example of the structure of the portion where the fourth inkjet head is provided;

FIGS. 5A to 5C are diagrams showing another configuration example of a shielding member;

FIGS. 6A to 6C are diagrams showing another configuration example;

FIGS. 7A to 7C are diagrams showing still another configuration example;

FIGS. 8A and 8B are diagrams showing another movement of a first shielding member and a second shielding member;

FIGS. 9A and 9B are diagrams showing another configuration example; and

FIGS. 10A and 10B are diagrams showing still another configuration example.

### DESCRIPTION OF EMBODIMENT

Hereinafter, an exemplary embodiment according to the present invention will be described with reference to attached drawings.

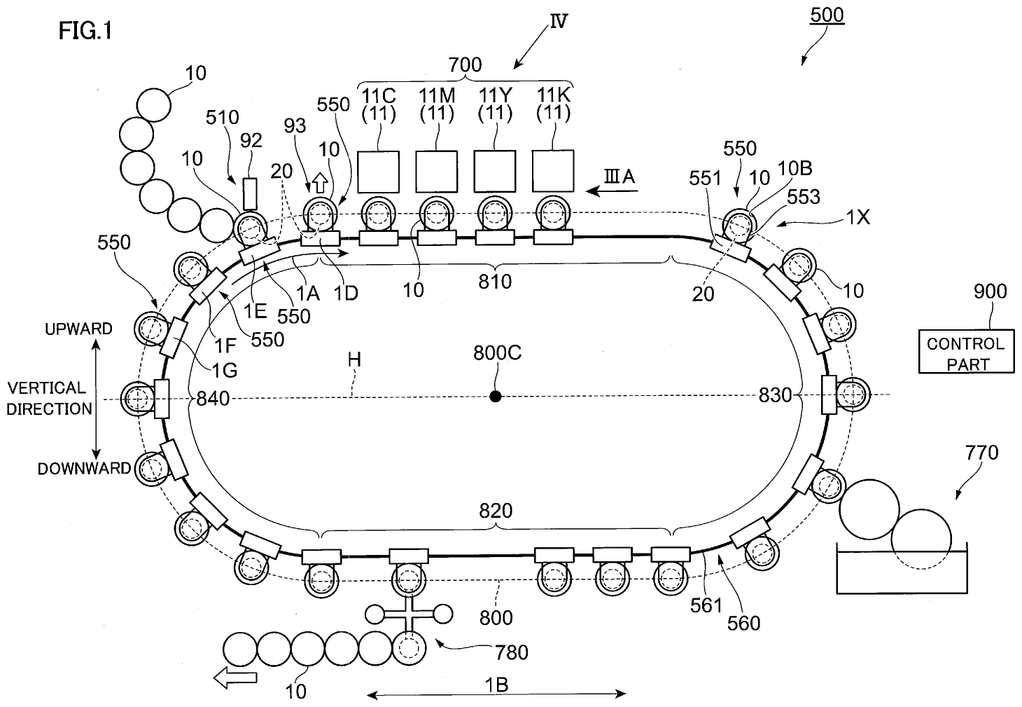

FIG. 1 is a side elevational view of a printing apparatus 500.

The printing apparatus 500 is provided with a can body supply part 510 to which can bodies 10 are supplied. In the can body supply part 510, the can body 10 is supplied (attached) to a support member 20 supporting the can body 10.

Specifically, the support member 20 is formed into a cylindrical shape, and inserted into the cylindrically-shaped can body 10; thereby the can body 10 is supplied to the support member 20.

Further, the can body supply part 510 is provided with an inspection device 92.

The inspection device 92 inspects whether or not the can body 10 has been deformed.

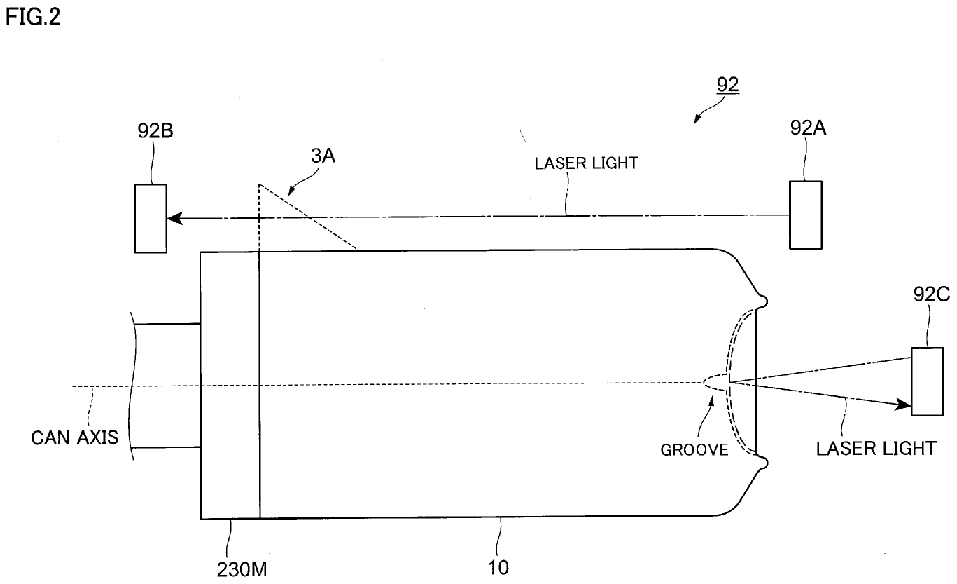

More specifically, as shown in FIG. 2 (a diagram illustrating the inspection device 92), the inspection device 92 is provided with a light source 92A.

The light source 92A is provided at one end portion side of the can body 10, and the light source 92A emits laser light that proceeds along an axial direction of the can body 10 and along the outer circumferential surface of the can body 10. Further, at the other end portion side of the can body 10, there is provided a light receiving part 92B that receives laser light from the light source 92A.

If part of the can body 10 is deformed as indicated by the reference sign 3A, the laser light is cut off and the light receiving part 92B cannot receive the laser light. Consequently, deformation of the can body 10 is detected.

Then, in the exemplary embodiment, when it is determined by the inspection device 92 that the can body 10 does not satisfy predetermined conditions (when it is determined that the can body 10 is deformed), a discharge mechanism 93 (refer to FIG. 1) discharges the can body 10 to the outside of the printing apparatus 500.

The discharge mechanism 93 is disposed between the inspection device 92 and an inkjet printing part 700 (disposed on an upstream side of the inkjet printing part 700).

In the exemplary embodiment, before image formation by the inkjet printing part 700 is performed, the deformed can body 10 is discharged from the printing apparatus 500.

In the discharge mechanism 93, compressed air is supplied to the inside of the cylindrically-formed support member 20, to move the can body 10 in the axial direction thereof (in the direction orthogonal to the page of FIG. 1).

Further, the bottom portion of the can body 10 is sucked by a not-shown suction member. Then, by the suction member, the can body 10 is conveyed to the outside of the printing apparatus 500; thereby the can body 10 is discharged to the outside of the printing apparatus 500.

On a downstream side of the discharge mechanism 93, the inkjet printing part 700 is provided.

The inkjet printing part 700 forms an image on the can body 10, which has been moved from the upstream side, using the inkjet printing method.

To additionally describe, in the exemplary embodiment, when image formation by the inkjet printing part 700 is performed, the moving units 550 sequentially move from the upstream side of the inkjet printing part 700 toward the inkjet printing part 700 (refer to the arrow 1A).

Then, in the exemplary embodiment, image formation by the inkjet printing part 700 is performed onto the can bodies 10 on the moving units 550.

Here, the image formation by the inkjet printing method refers to image formation performed by ejecting ink from inkjet heads 11 to attach the ink to the can body 10.

In the image formation by the inkjet printing method, known methods can be used. Specifically, for example, the piezo system, the thermal (bubble) system, or the continuous system can be used.

A protection layer forming part 770 is disposed on the downstream side of the Inkjet printing part 700.

The protection layer forming part 770 applies transparent paint on the image formed by the inkjet printing part 700, to thereby form a transparent layer covering the image. Consequently, in the exemplary embodiment, a transparent protection layer is formed as the outermost layer of the can body 10.

On the downstream side of the protection layer forming part 770, a detachment part 780 detaching the can body 10 from the support member 20 is provided.

The can body 10 is detached from the support member 20 in the detachment part 780, and discharged to the outside of the printing apparatus 500.

Further, the printing apparatus 500 is provided with plural provided moving units 550 as an example of moving bodies that move while supporting the can bodies 10.

In the exemplary embodiment, the support member 20 supporting the can body 10 is, as indicated by the reference sign 1X, attached to the moving unit 550, and the can body 10 moves together with the moving unit 550.

Note that, in the exemplary embodiment, the description is given of the case in which the moving unit 550 supports one can body 10; the moving unit 550 may support plural can bodies 10.

The support member 20 is formed into a cylindrical shape and further, provided in a state being rotatable in the circumferential direction. In the exemplary embodiment, the can body 10 is supported by the support member 20 that is rotatable in the circumferential direction, and thereby the can body 10 is supported in the state being rotatable in the circumferential direction.

The can body 10 is formed into a cylindrical shape and an opening portion 10B is provided at one end thereof. In addition, the other end of the can body 10 is closed and the other end is provided with a bottom portion. The support member 20 is inserted into the can body 10 from the opening portion 10B.

Further, in the exemplary embodiment, there is provided a moving mechanism 560 functioning as a mover unit that moves the moving units 550. The moving mechanism 560 is provided with an annular guide member 561 that guides the moving units 550.

Each of the moving units 550 is guided by the guide member 561 and orbitally moves along a predetermined annular moving route 800.

With this, in the exemplary embodiment, the support member 20 provided to the moving unit 550 and the can body 10 supported by the support member 20 also move along the predetermined annular moving route 800.

The moving route 800 is disposed so that the axial center 800C thereof is arranged along the horizontal direction. To put it another way, the moving route 800 is disposed around the axial center 800C that is along the horizontal direction. Here, the axial center 800C extends in the direction orthogonal to the page in FIG. 1.

In this case, in the exemplary embodiment, the support member 20 and the can body 10 orbitally move around the axial center 800C extending in the direction orthogonal to the page in the figure.

The moving route 800 is provided with the first linear part 810, which is a linear moving route, and a second linear part 820, which is also a linear moving route.

Each of the first linear part 810 and the second linear part 820 is disposed to extend along the horizontal direction. In addition, the first linear part 810 and the second linear part 820 are disposed to be substantially in parallel with each other. Further, in the exemplary embodiment, the first linear part 810 is disposed above the second linear part 820.

Further, the first linear part 810 is provided at an uppermost portion of the annular moving route 800, whereas the second linear part 820 is provided at a lowermost portion of the annular moving route 800.

Further, in the exemplary embodiment, the inkjet printing part 700 is provided above the first linear part 810, where the uppermost portion is located.

Further, the moving route 800 is provided with a first curved part 830 and a second curved part 840, each of which is formed into an arc with a curvature.

The first curved part 830 connects a right end portion of the first linear part 810 in the figure and a right end portion of the second linear part 820 in the figure. In addition, the first curved part 830 is formed to head downward from above.

Moreover, the second curved part 840 connects a left end portion of the first linear part 810 in the figure and a left end portion of the second curved part 820 in the figure. In addition, the second curved part 840 is formed to head upward from below.

The inkjet printing part 700 will be described.

The inkjet printing part 700 is disposed above the first linear part 810 to perform image formation onto the can bodies 10 positioned on the first linear part 810.

The inkjet printing part 700 is provided with plural inkjet heads 11 arranged in line in the left and right directions in the figure.

Specifically, the inkjet printing part 700 is provided with a first inkjet head 11C ejecting cyan ink, a second inkjet head 11M ejecting magenta ink, a third inkjet head 11Y ejecting yellow ink, and a fourth inkjet head 11K ejecting black ink.

In the following description, when the first inkjet head 11C to the fourth inkjet head 11K are not particularly distinguished, the inkjet heads are simply referred to as “inkjet heads 11.”

Note that, in the exemplary embodiment, the case in which the four inkjet heads 11 were provided was shown as an example; however, an inkjet head 11 ejecting ink of a special color, such as a corporate color, or an inkjet head 11 for forming a white layer may be further provided.

Here, the four inkjet heads 11, namely, the first inkjet head 11C to the fourth inkjet head 11K perform image formation onto the can body 10 by use of ultraviolet cure ink.

In other words, the four inkjet heads 11 perform image formation onto the can body 10 by using photo-curable ink, which cures upon being irradiated with light such as ultraviolet rays.

In addition, in the exemplary embodiment, the can body 10 is moved in a state of being laid (the can body 10 is moved in the state in which the axial direction of the can body 10 extends along the horizontal state), and a part of the outer circumferential surface of the can body 10 faces upward in the vertical direction.

In the exemplary embodiment, ink is ejected downwardly from above the outer circumferential surface, to thereby perform image formation onto the outer circumferential surface of the can body 10.

In addition, in the exemplary embodiment, the moving unit 550 stops under each of the inkjet heads 11 and the ink is ejected to the can body 10 on the moving unit 550, and thereby the image formation onto the can body 10 is performed.

Then, in the exemplary embodiment, when the image formation onto the can body 10 is finished, the moving unit 550 moves toward the next inkjet head 11 positioned on the downstream side, and the image formation onto the can body 10 is further performed by the inkjet head 11.

Further, in the exemplary embodiment, the four inkjet heads 11 are arranged in line along the moving direction of the can body 10. In addition, each of the four inkjet heads 11 is disposed along the direction orthogonal to (crossing) the moving direction of the can body 10.

In the exemplary embodiment, in a process in which the can body 10 passes below the four inkjet heads 11, ink is ejected to the can body 10 from above, and thereby a print image is formed on the can body 10.

More specifically, in the exemplary embodiment, the moving unit 550 stops at the installation point of each of the plural inkjet heads 11 that have been provided.

Then, in each of the inkjet heads 11, ink is ejected onto the can body 10, to thereby form an image onto the can body 10. Note that, when the image formation is performed in each of the inkjet heads 11, the can body 10 rotates in the circumferential direction.

In the exemplary embodiment, each of the stop points, where the moving unit 550 stops, is provided with a driving source such as a servomotor (not shown) that rotates the can body 10.

In the exemplary embodiment, when each of the moving units 550 reaches the stop point, the moving unit and the driving source are connected, and the rotational driving force is transmitted to the support member 20. Consequently, the support member 20 rotates, and with this, the can body 10 rotates in the circumferential direction.

The driving source is also provided in other places, such as the inspection device 92 and the protection layer forming part 770, and the can body 10 is also rotated by the driving source in the inspection device 92, the protection layer forming part 770, etc.

In addition, other than the above, the driving source may be provided in each of the moving units 550 to rotate the can body 10 by the driving source provided in each of the moving units 550.

Further, although the illustration is omitted in FIG. 1, in the exemplary embodiment, a light irradiation part 750 (to be described later) is provided at each of the installation points of the four inkjet heads 11.

In the exemplary embodiment, the light irradiation part 750 irradiates the outer circumferential surface of the can body 10 with light of wavelength in the ultraviolet range (hereinafter, referred to as “ultraviolet light” in some cases), to thereby cure the image formed on the outer circumferential surface of the can body 10.

Each of the moving units 550, as an example of a moving body, moves at a predetermined moving speed.

In addition, each of the moving units 550 stops at each of the can body supply part 510, the discharge mechanism 93, the respective inkjet heads 11, the protection layer forming part 770, and the detachment part 780.

Moreover, at the installation points such as the inspection device 92, the respective inkjet heads 11, and the protection layer forming part 770, the can body 10 on the moving unit 550 rotates in the circumferential direction at the predetermined rotation speed.

In addition, in the printing apparatus 500 of the exemplary embodiment, the moving units 550 of the number larger than the number of can bodies 10 located in the printing apparatus 500 are installed. Further, the moving units 550 move around the axial center 800C.

Inside the annular guide member 561 that guides the moving units 550, electromagnets (not shown) are provided.

Further, a permanent magnet (not shown) is installed to the moving unit 550.

In the exemplary embodiment, the linear-motor mechanism is used to move the moving units 550. Note that the moving units 550 can be moved by using publicly known other mechanisms, not only by using the linear-motor mechanism. For example, a driving source such as a motor may be provided to each of the moving units 550, to thereby make each of the moving units 550 move by itself.

The printing apparatus 500 of the exemplary embodiment is provided with a control part 900 that controls energization to the above-described electromagnets to generate magnetic fields for moving each of the moving units 550.

The control part 900 is configured with a program-controlled CPU (Central Processing Unit).

As indicated by the reference sign 1X in FIG. 1, the moving unit 550 is provided with a pedestal part 551 guided by the guide member 561. In the pedestal part 551, the permanent magnet (not shown) is installed.

In the exemplary embodiment, a propulsive force occurs in the moving unit 550 by magnetic fields generated by the electromagnets provided to the guide member 561 and the permanent magnet provided to the pedestal part 551 of the moving unit 550, and thereby the moving unit 550 moves along the annular moving route 800.

Further, the moving unit 550 of the exemplary embodiment is, as indicated by the reference sign 1X, provided with the cylindrical support member 20 supporting the can body 10 and a fixing member 553 for fixing the support member 20 to the pedestal part 551. The fixing member 553 is provided in the shape to stand from the pedestal part 551.

The support member 20 of the exemplary embodiment is formed into the cylindrical shape, and inserted into the can body 10 through the opening portion 10B formed in the can body 10 to support the can body 10. In addition, the support member 20 is disposed in the state of being laid (along the horizontal direction). Consequently, in the exemplary embodiment, the can body 10 is also disposed in the state of being laid.

In the exemplary embodiment, when the can body 10 reaches each of the inkjet heads 11, ink is ejected from each of the inkjet heads 11 to the can body 10 positioned below. Consequently, an image is formed on the outer circumferential surface of the can body 10.

In the exemplary embodiment, the moving unit 550 stops every time the moving unit 550 reaches below each of the inkjet heads 11. In other words, the moving unit 550 stops at each of predetermined stop points.

Then, in the exemplary embodiment, onto the outer circumferential surface of the can body 10 held by the moving unit 550 stopped at the predetermined stop point, an image is formed by the inkjet heads 11 as an example of a printing unit.

More specifically, at each of the installation points of the inkjet heads 11, ejection of ink from the inkjet head 11 is performed in the state in which the support member 20 (the can body 10) rotates in the circumferential direction, to thereby form a print image onto the outer circumferential surface of the can body 10.

In the exemplary embodiment, when the support member 20 rotates 360° after ejection of ink is started, ejection of ink is stopped. Consequently, the print image is formed on the entire region in the circumferential direction of the outer circumferential surface of the can body 10.

In the exemplary embodiment, the support member 20 shown in FIG. 1 is disposed along the direction orthogonal to the page of FIG. 1. To put it another way, the support member 20 is disposed to extend along the horizontal direction. In addition, the support member 20 is disposed along the direction orthogonal to (crossing) the moving direction of the moving unit 550.

Note that, not limited to the above, the support member 20 may be disposed along the moving direction of the moving unit 550. In this case, the inkjet heads 11 are also disposed along the moving direction of the moving unit 550.

In addition, in the exemplary embodiment, the inkjet heads 11 are located above the can body 10, and the ink is ejected to the can body 10 from above.

In this case, as compared to a case in which the inkjet heads 11 are disposed at the lateral side of the can body 10 or below the can body 10, it is possible to reduce the effect of gravity acting on ink droplets ejected from the inkjet heads 11, to thereby increase accuracy of ink adhesive positions on the can body 10.

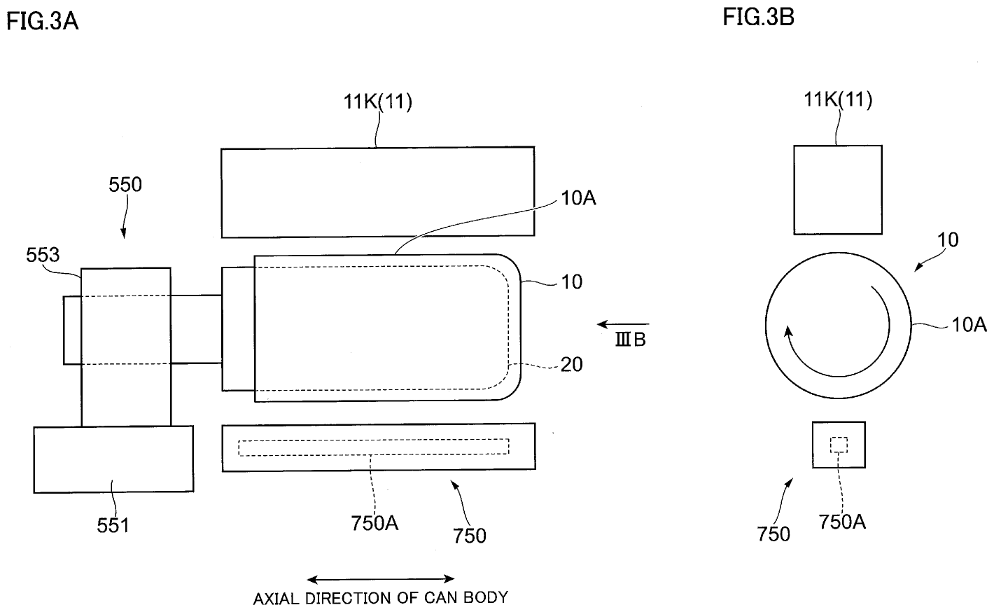

FIGS. 3A and 3B are diagrams showing a structure of a portion where the fourth inkjet head 11K is provided.

More specifically, FIG. 3A is a diagram in the case where the moving unit 550 and the fourth inkjet head 11K are viewed from the direction indicated by the arrow IIIA in FIG. 1. FIG. 3B is a diagram in the case where the can body 10, the fourth inkjet head 11K, etc. are viewed from the direction indicated by the arrow IIIB in FIG. 3A.

Note that, in the exemplary embodiment, the configuration in the installation point of each of the first inkjet head 11C (refer to FIG. 1) to the third inkjet head 11Y is similar to the configuration shown in FIG. 3.

In the exemplary embodiment, the fourth inkjet head 11K as an example of the printing unit is disposed to the position facing the outer circumferential surface 10A of the can body 10, and ejects ink to the outer circumferential surface 10A of the rotating can body 10, to thereby perform printing on the outer circumferential surface 10A.

The fourth inkjet head 11K is, as shown in FIG. 3A, disposed above the can body 10, as well as disposed in the state of being laid along the axial direction of the can body 10.

Further, in the exemplary embodiment, the light irradiation part 750 as an example of a curing unit is provided on a side opposite to the installation side of the fourth inkjet head 11K across the can body 10.

The light irradiation part 750 includes a light source 750A to irradiate the outer circumferential surface 10A of the can body 10, on which the print image has been formed by the fourth inkjet head 11K, with ultraviolet light. This cures the print image on the outer circumferential surface 10A.

The light irradiation part 750 is disposed below the can body 10, and irradiates upwardly with ultraviolet light to cure the print image from below the can body 10.

Here, in the exemplary embodiment, ultraviolet light emitted from the light irradiation part 750 is blocked by can body 10, and hardly reaches the fourth inkjet head 11K.

To put it another way, in the exemplary embodiment, as shown in FIG. 3B, the can body 10 is positioned between the light irradiation part 750 and the fourth inkjet head 11K, and therefore, ultraviolet light from the light irradiation part 750 hardly reaches the fourth inkjet head 11K.

Consequently, it is less likely that clogging of the fourth inkjet head 11K occurs due to ultraviolet light reaching the fourth inkjet head 11K.

Further, in the exemplary embodiment, as shown in FIG. 3B, the light irradiation part 750 turns on the light source 750A when the can body 10 is at the position facing the light irradiation part 750, to thereby irradiates the outer circumferential surface 10A of the can body 10 with light.

More specifically, in the exemplary embodiment, there is provided a sensor (not shown) detecting the can body 10 existing at the position facing the light irradiation part 750, and when the can body 10 is detected by the sensor, the light irradiation part 750 turns on the light source 750A.

In other words, the light irradiation part 750 turns off the light source 750A or reduces the output of the light source 750A in the case where the can body 10 does not exist at the position facing the light source 750A.

More specifically, in the case where the can body 10 is not detected by the sensor, the light irradiation part 750 turns off the light source 750A or reduces the output of the light source 750A.

In the case where the light source 750A is turned off or the output of the light source 750A is reduced when there is no can body 10 at the position facing the light source 750A, the ultraviolet light does not reach the fourth inkjet head 11K.

### Other Configuration Examples

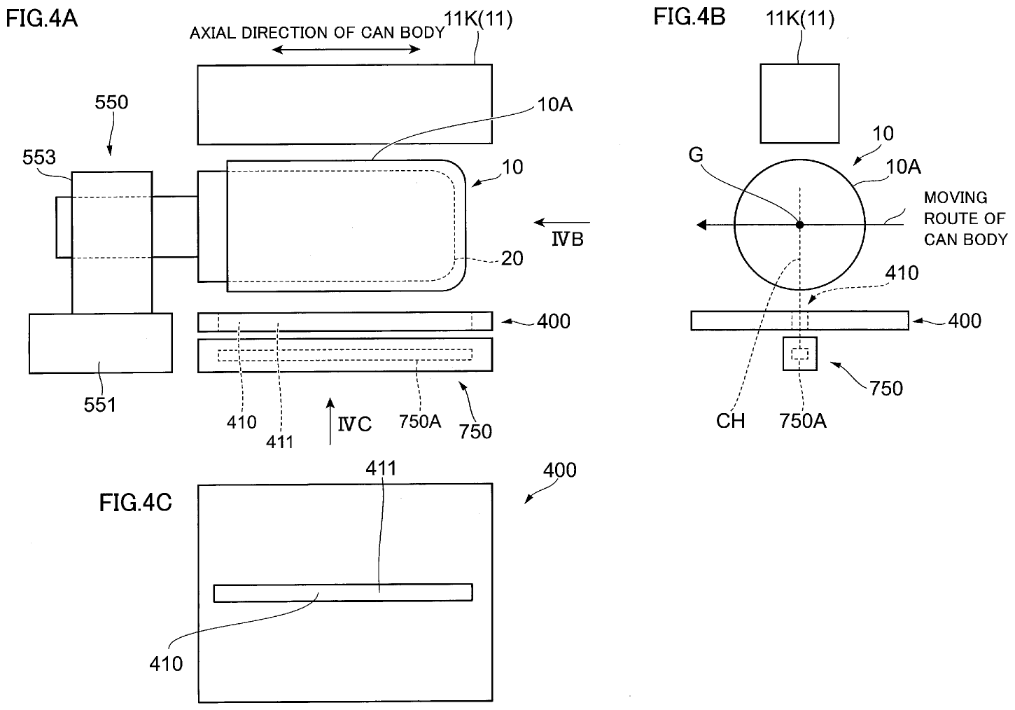

FIGS. 4A to 4C are diagrams showing another configuration example of the portion where the fourth inkjet head 11K is provided. Here, FIG. 4C is a diagram in the case where a shielding member 400 is viewed from the direction indicated by the arrow IVC in FIG. 4A.

In the configuration example, there is provided the shielding member 400 that shields the light from the light irradiation part 750 toward the fourth inkjet head 11K.

In the exemplary embodiment, the shielding member 400 reduces ultraviolet light toward the fourth inkjet head 11K passing through both sides of the can body 10 shown in FIG. 4B.

As shown in FIGS. 4A and 4B, the shielding member 400 is provided between the light irradiation part 750 and the fourth inkjet head 11K.

In addition, as shown in FIG. 4B, the shielding member 400 is formed into a plate shape and is disposed beside the moving route of the can body 10, and further, disposed in the state of being along the moving route. The shielding member 400 is also disposed between the moving route of the can body 10 and the light irradiation part 750.

Here, the shape and material of the shielding member 400 are not limited in particular. The shielding member 400 may be formed not only in the plate shape but also in the sheet shape. In addition, the shielding member 400 is composed of the metal material or the resin material.

In the exemplary embodiment, the shielding member 400 further reduces the light from the light irradiation part 750 toward the fourth inkjet head 11K.

As shown in FIGS. 4A to 4C, the shielding member 400 is provided with a portion 410 for passing light from the light irradiation part 750 toward the outer circumferential surface 10A of the can body 10 (hereinafter referred to as a “light passing portion 410”).

As shown in FIG. 4B, the light passing portion 410 is located on a straight line CH that connects the light source 750A and the axial center G of the can body 10. In other words, the light passing portion 410 is located on an optical path of the ultraviolet light from the light source 750A toward the can body 10.

Further, in the exemplary embodiment, when the light passing portion 410 is assumed as a starting point, the shielding member 400 is disposed to extend toward both upstream and downstream sides in the moving direction of the can body 10.

In the exemplary embodiment, the light emitted from the light source 750A of the light irradiation part 750 passes the light passing portion 410 toward the outer circumferential surface 10A of the can body 10, and the outer circumferential surface 10A is irradiated with the light. Similar to the above, this cures the print image on the outer circumferential surface 10A of the can body 10.

In the exemplary embodiment, as shown in FIG. 4C, the light passing portion 410 is configured with an opening (through hole) 411 formed in the shielding member 400.

As shown in FIGS. 4A and 4C, the opening 411 is formed to extend along the axial direction of the can body 10. Also, in the exemplary embodiment, the dimension of the opening 411 in the longitudinal direction is larger than the dimension of the can body 10 in the longitudinal direction.

In the configuration example in FIG. 4, as shown in FIG. 4B, the light irradiation part 750 also turns on the light source 750A to irradiate the outer circumferential surface 10A of the can body 10 through the light passing portion 410 when the can body 10 exists at the position facing the light irradiation part 750.

More specifically, in the configuration example, there is provided the sensor (not shown) detecting the can body 10 existing at the position facing the light irradiation part 750, and when the can body 10 is detected by the sensor, the light irradiation part 750 turns on the light source 750A.

On the other hand, the light irradiation part 750 turns off the light source 750A or reduces the output of the light source 750A in the case where the can body 10 does not exist at the position facing the light passing portion 410.

More specifically, in the case where the can body 10 is not detected by the sensor, the light irradiation part 750 turns off the light source 750A or reduces the output of the light source 750A.

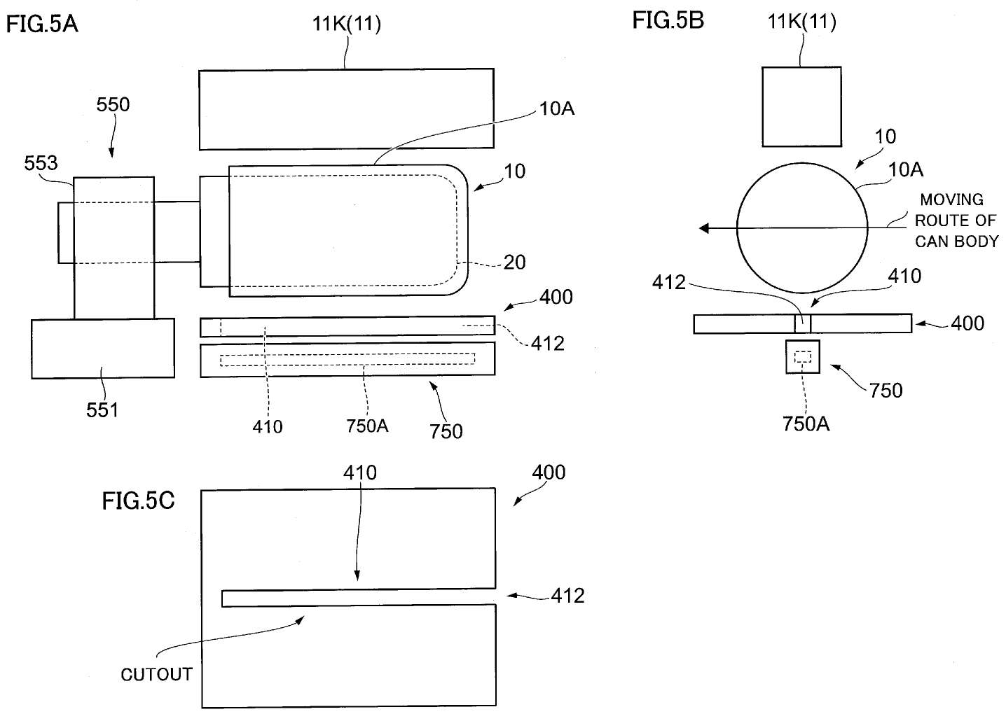

Note that, in the exemplary embodiment, the description has been given of the case where the light passing portion 410 was configured with the opening 411; however, the light passing portion 411 is not limited to the opening, and may be configured with a cutout 412 formed in the shielding member 400 as shown in FIG. 5C (FIG. 5 shows another configuration example of the shielding member 400).

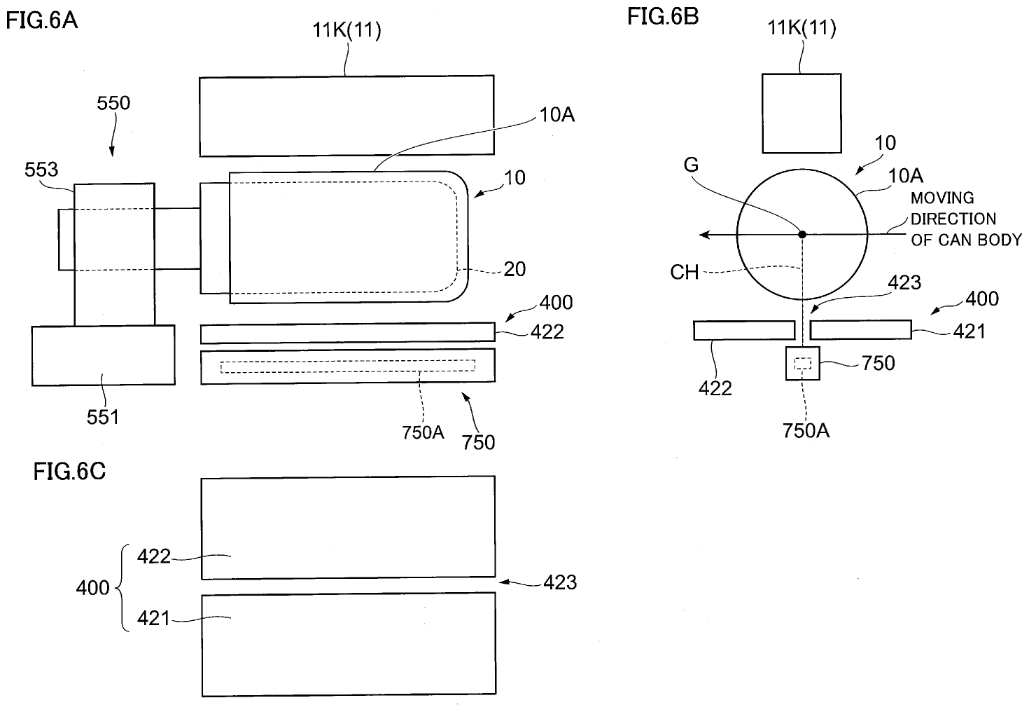

FIGS. 6A to 6C are diagrams showing still another configuration example.

In the configuration example, plural shielding members 400 are provided. Specifically, as shown in FIGS. 6B and 6C, a first shielding member 421 and a second shielding member 422 are provided as the shielding member 400.

As shown in FIG. 6B, in the moving direction of the can body 10, the first shielding member 421 and the second shielding member 422 are disposed with their installation positions shifted from each other.

Specifically, in the exemplary embodiment, in the moving direction of the can body 10, the first shielding member 421 is disposed on the upstream side of the second shielding member 422.

In addition, in the configuration example, as shown in FIGS. 6B and 6C, a gap 423 for allowing the light from the light irradiation part 750 to head for the outer circumferential surface 10A of the can body 10 is provided between the first shielding member 421 and the second shielding member 422.

In the exemplary embodiment, as shown in FIG. 6B, the gap 423 is located on a straight line CH that connects the light source 750A and the axial center G of the can body 10. In other words, the gap 423 is located on an optical path of the ultraviolet light from the light source 750A toward the can body 10.

Further, in the exemplary embodiment, when the gap 423 is assumed as a starting point, the first shielding member 421 extends toward the upstream side in the moving direction of the can body 10, and the second shielding member 422 extends toward the downstream side in the moving direction of the can body 10.

In the configuration example, the light irradiation part 750 also turns on the light source 750A to irradiate the outer circumferential surface 10A of the can body 10 through the gap 423 when the can body 10 exists at the position facing the light irradiation part 750.

More specifically, similar to the above, in the case where the can body 10 is detected by the sensor, the light irradiation part 750 turns on the light source 750A. In addition, the light irradiation part 750 turns off the light source 750A or reduces the output of the light source 750A in the case where the can body 10 does not exist at the position facing the gap 423.

Also in the configuration example, this makes it possible to irradiate the can body 10 with the ultraviolet light, while making it difficult for the ultraviolet light to reach the fourth inkjet head 11K in the case where the can body 10 does not exist at the position facing the gap 423.

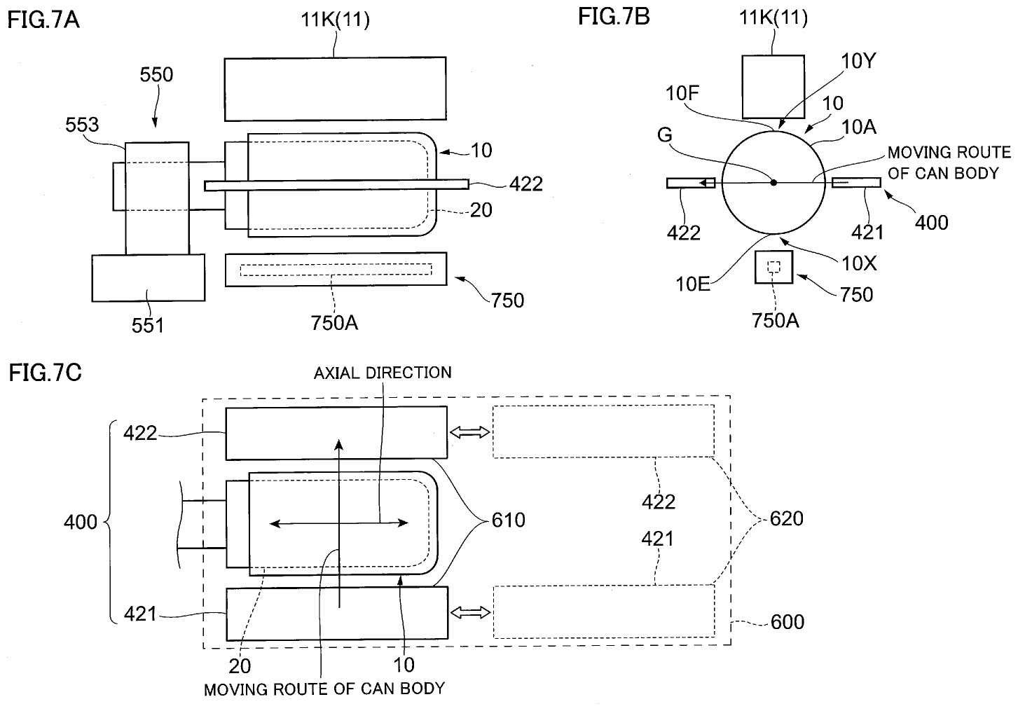

FIGS. 7A to 7C are diagrams showing still another configuration example.

In the configuration example, similar to the above, the first shielding member 421 and the second shielding member 422 are provided as the shielding member 400. In addition, in the configuration example, as shown in FIG. 7B, the can body 10 is located between the first shielding member 421 and the second shielding member 422.

In the configuration examples shown in the above FIGS. 4 to 6, the shielding member 400 was provided on the lateral side of the moving route of the can body 10; however, in this configuration example, the shielding member 400 is provided on the moving route of the can body 10, as shown in FIG. 7B. In other words, in the configuration example, the first shielding member 421 and the second shielding member 422 are provided on the moving route of the can body 10 as shown in FIG. 7B.

In the configuration example, the portion indicated by the reference sign 10X in FIG. 7B is the facing portion 10E of the outer circumferential surface 10A of the can body 10, which faces the light irradiation part 750.

In addition, in the exemplary embodiment, the portion indicated by the reference sign 10Y is the opposite portion 10F of the outer circumferential surface 10A of can body 10, which is located on the opposite side of the facing portion 10E across the axial center G.

The can body 10 in the exemplary embodiment is cylindrically formed and has the axial center G. In the exemplary embodiment, the opposite portion 10F is located on the opposite side of the facing portion 10E across the axial center G.

In the configuration example, as shown in FIG. 7B, the first shielding member 421 and the second shielding member 422 are disposed closer to the fourth inkjet head 11K than the facing portion 10E. In addition, the first shielding member 421 and the second shielding member 422 are disposed closer to the light irradiation part 750 than the opposite portion 10F.

Further, in the configuration example, as shown in FIG. 7C, there is provided a moving mechanism 600 as an example of the mover unit that moves the first shielding member 421 and the second shielding member 422. As shown in FIG. 7C, the moving mechanism 600 moves the first shielding member 421 and the second shielding member 422 along the axial direction of the can body 10.

In the exemplary embodiment, as the installation position of the first shielding member 421 and the second shielding member 422, a shielding position 610 that is located on the moving route of the can body 10 and shields the light from the light irradiation part 750 is set, as shown in FIG. 7C.

In addition, in the exemplary embodiment, an out-of-route position 620 that is the position deviated from the moving route of the can body 10 is set, as shown in FIG. 7C.

The moving mechanism 600 moves the first shielding member 421 and the second shielding member 422 from one of the shielding position 610 and the out-of-route position 620 to the other. In addition, the moving mechanism 600 moves the first shielding member 421 and the second shielding member 422 from the other position to the one position.

More specifically, the moving mechanism 600 locates the first shielding member 421 and the second shielding member 422 at the out-of-route position 620 when the can body 10 is conveyed to the position facing the light irradiation part 750.

Then, when the can body 10 stops at the position facing the light irradiation part 750, the moving mechanism 600 moves the first shielding member 421 and the second shielding member 422 to the shielding position 610.

Thereafter, in the exemplary embodiment, in the state where the first shielding member 421 and the second shielding member 422 are positioned at the shielding position 610, image formation onto the can body 10 and irradiation of the can body 10 with the ultraviolet light are performed.

After that, in the exemplary embodiment, the moving mechanism 600 moves the first shielding member 421 and the second shielding member 422 to the out-of-route position 620.

Consequently, the first shielding member 421 and the second shielding member 422 are located at the positions deviated from the moving route of the can body 10. Thereafter, the can body 10 is conveyed to the downstream side.

Note that, in the configuration example shown in FIG. 7, the description was given of the case in which the first shielding member 421 and the second shielding member 422 moved in the axial direction of the can body 10 to the positions deviated from the moving route of can body 10.

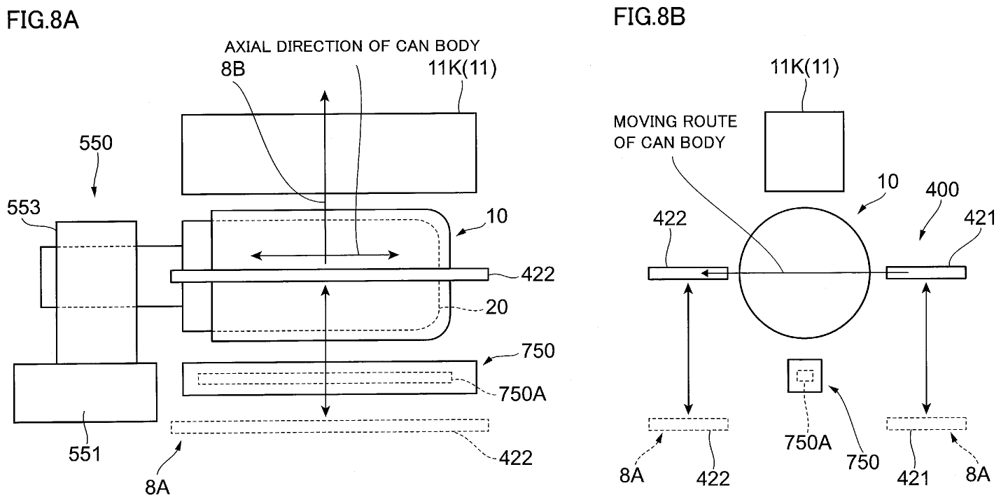

By the way, not limited to the above, the first shielding member 421 and the second shielding member 422 may be moved as shown in FIG. 8 (the diagram showing another movement of the first shielding member 421 and the second shielding member 422).

In the configuration example shown in FIG. 8, the first shielding member 421 and the second shielding member 422 are moved in the direction orthogonal to (crossing) the axial direction of the can body 10.

In addition, in the configuration example, as indicated by the reference sign 8A in FIGS. 8A and 8B, the first shielding member 421 and the second shielding member 422 are moved to the point located closer to the side on which the light irradiation part 750 is provided and deviated from the moving route of the can body 10.

Note that, other than this, in the case where the first shielding member 421 and the second shielding member 422 are moved in the direction orthogonal to the axial direction of the can body 10, the first shielding member 421 and the second shielding member 422 may be moved to the side on which the fourth inkjet head 11K, as indicated by the arrow 8B in FIG. 8A.

In addition, one of the first shielding member 421 and the second shielding member 422 may be moved closer to the light irradiation part 750, and the other may be moved closer to the fourth inkjet head 11K.

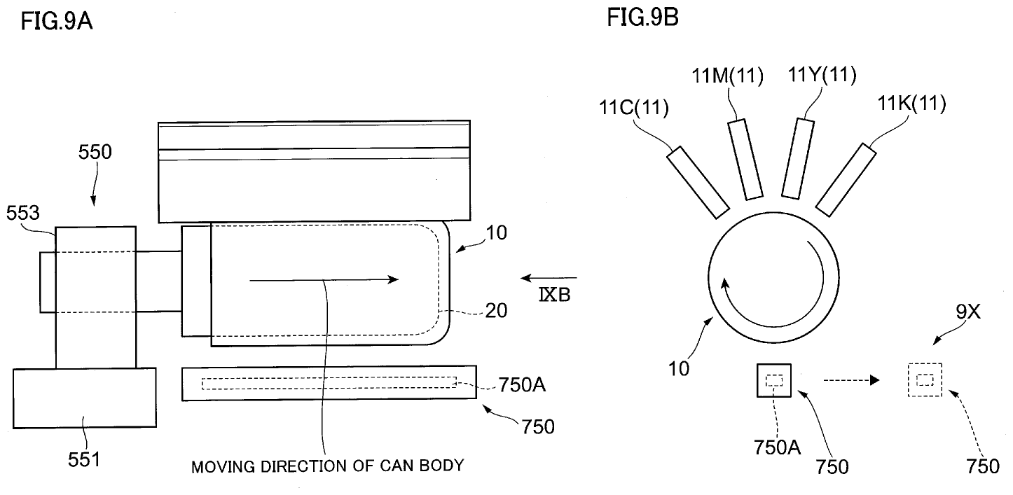

FIGS. 9A and 9B are diagrams showing still another configuration example. Note that FIG. 9B shows the case where the can body 10 and the like are viewed from the direction indicated by the arrow IXB in FIG. 9A.

In the configuration example, as shown in FIG. 9B, plural inkjet heads 11 are radially disposed. In addition, in the configuration example, the can body 10 moves along the longitudinal direction of the inkjet head 11, as shown in FIG. 9A.

In the configuration example, in the printing apparatus 500 shown in FIG. 1, the can body 10 moves along the axial direction of the can body 10. Moreover, in the configuration example, each inkjet head 11 is disposed along the axial direction of the can body 10.

Further, in the configuration example, as shown in FIG. 9B, the light irradiation part 750 is provided on the side opposite to the installation side of the plural inkjet heads 11 across the can body 10.

In the configuration example, the light from the light irradiation part 750 is also blocked by the can body 10; accordingly, ultraviolet light from the light irradiation part 750 toward the plural inkjet heads 11 is reduced.

In addition, also in the configuration example, similar to the above, the light source 750A of the light irradiation part 750 is turned on in the case where the can body 10 is located at the position facing the light irradiation part 750.

In addition, in the case where the can body 10 is not located at the position facing the light irradiation part 750, the light source 750A of the light irradiation part 750 is turned off, or the output of the light source 750A is reduced.

Further, in the configuration example, to avoid interference between the light irradiation part 750 and the pedestal part 551 (refer to FIG. 9A), the light irradiation part 750 is moved to the position indicated by the reference sign 9X in FIG. 9B when the can body 10 (the moving unit 550) is moved to the downstream side from the position facing the light irradiation part 750. Specifically, the light irradiation part 750 is moved to a point deviated from the moving route of the moving unit 550.

In addition, in the exemplary embodiment, when the light irradiation part 750 is located at the point deviated from the moving route of the moving unit 550, the light source 750A of the light irradiation part 750 is turned off, or the output of the light source 750A is reduced.

As shown in FIG. 1, the inkjet heads 11 may be disposed at positions shifted in the moving direction of the can body 10, or the plural inkjet heads 11 may be provided at one location as shown in FIG. 9.

In addition, in FIG. 9, the shielding member 400 is not installed; however, similar to the configuration example shown in FIG. 4, the shielding member 400 including the light passing portion 410 may be disposed between the light irradiation part 750 and the can body 10.

Moreover, in the configuration example shown in FIG. 9, any of the shielding members 400 shown in FIGS. 5 to 8 may also be installed.

Note that, in the case where any of the shielding members 400 shown in FIGS. 4 to 6 is installed, to avoid interference between the moving unit 550 and the shielding member 400, similar to the above light irradiation part 750 (the light irradiation part 750 indicated by the reference sign 9X), the shielding member 400 is moved to a point deviated from the moving route of the moving unit 550 when the moving unit 550 moves to the downstream side.

Note that, in the configuration example shown in FIG. 9, if the first shielding member 421 and the second shielding member 422 shown in FIGS. 7 and 8 are installed, the first shielding member 421 and the second shielding member 422 do not need to move.

In the configuration example shown in FIG. 9, if the first shielding member 421 and the second shielding member 422 shown in FIGS. 7 and 8 are installed, the first shielding member 421 and the second shielding member 422 are not located on the moving route of the can body 10, but located on the lateral side of the moving route.

In this case, it is possible to avoid interference between the first shielding member 421 and the second shielding member 422 and the can body 10 without moving the first shielding member 421 and the second shielding member 422.

In the configuration example shown in FIG. 9, the description has been given of the case in which the can body 10 is moved along the axial direction of the can body 10, and the plural inkjet heads 11 are disposed along the moving direction.

Here, even in the state where the plural inkjet heads are installed separately as shown in FIG. 1, the can body 10 may be moved along the axial direction of the can body 10, and each inkjet head 11 may be disposed along the moving direction.

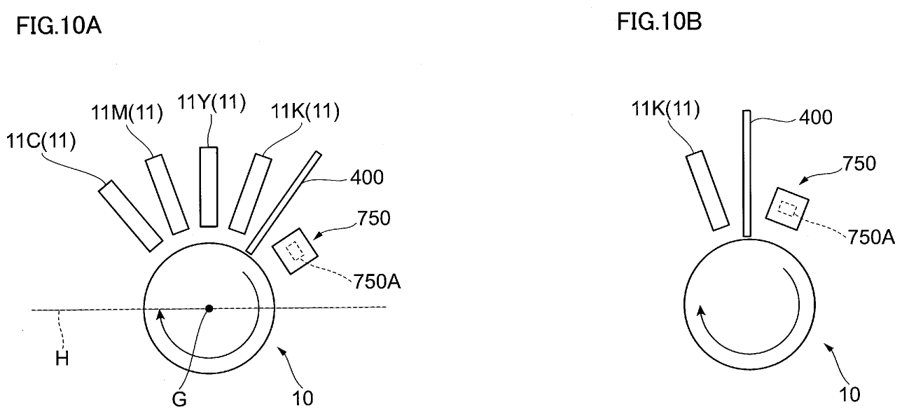

FIGS. 10A and 10B are diagrams showing still another configuration example.

In the configuration example, similar to the configuration example shown in FIG. 9, the can body 10 is moved along the axial direction of the can body 10, and the plural inkjet heads 11 are provided along the axial direction of the can body.

In addition, in the configuration example, as shown in FIG. 10A, four inkjet heads 11 are disposed radially, and the light irradiation part 750 is provided beside the four inkjet heads 11.

More specifically, in the configuration example, the light irradiation part 750 is provided beside the four inkjet heads 11 and on the downstream side of the four inkjet heads 11 in the rotation direction of the can body 10.

The light irradiation part 750 may be installed beside the inkjet heads 11 as in the configuration example, not limited to be provided on the opposite side of the side where the inkjet heads 11 are provided across the can body 10.

In other words, in the configuration example shown in FIG. 10A, both the four inkjet heads 11 and the light irradiation part 750 are disposed above the horizontal plane H that passes through the axial center G of the can body 10. Then, in the configuration example, the light irradiation part 750 is provided on the lateral side of the four inkjet heads 11.

Further, in the configuration example, between the four inkjet heads 11 and the light irradiation part 750, there is provided the shielding member 400 that extends along the axial direction of the can body 10 and along the radial direction of the can body 10.

In the exemplary embodiment, ultraviolet light from the light irradiation part 750 toward the inkjet heads 11 is also reduced by the shielding member 400.

Here, in the present specification, “ultraviolet light from the light irradiation part 750 toward the inkjet heads 11” is not limited to the ultraviolet light directly from the light irradiation part 750 toward the inkjet heads 11.

“Ultraviolet light from the light irradiation part 750 toward the inkjet head 11” includes ultraviolet light reflected on the surface of the can body 10 or members other than the can body 10 and directed toward the inkjet heads 11.

In addition, “the shielding member 400 shields ultraviolet light” does not only mean that the ultraviolet light directly from the light irradiation part 750 toward the inkjet heads 11 is shielded by the shielding member 400. “The shielding member 400 shields ultraviolet light” also includes the fact that the ultraviolet light reflected on the surface of the can body 10 or other members and directed toward the inkjet heads 11 is shielded by the shielding member 400.

FIG. 10B is a diagram showing another configuration example of an installation portion of one inkjet head 11 in the case where the four inkjet heads 11 are disposed at the locations different from one another as shown in FIG. 1.

Specifically, FIG. 10B shows another configuration example in the installation portion of the fourth inkjet head 11K. Note that the configuration in each of the first inkjet head 11C to the third inkjet head 11Y is the same as the configuration shown in FIG. 10B.

In the configuration example, the light irradiation part 750 is provided beside the fourth inkjet head 11K. To put it another way, in the rotation direction of the can body 10, the light irradiation part 750 is provided on the downstream side of the fourth inkjet head 11K.

Further, also in the configuration example, between the fourth inkjet head 11K and the light irradiation part 750, there is provided the shielding member 400 that extends along the axial direction of the can body 10 and along the radial direction of the can body 10.

In the exemplary embodiment, ultraviolet light from the light irradiation part 750 toward the fourth inkjet head 11K is also reduced by the shielding member 400.

### (Others)

In the above, the description has been given with the case in which a print image is formed on the outer circumferential surface 10A of the can body 10 using photo-curable ink, and then the print image is cured by being irradiated with light (ultraviolet light) as an example.

By the way, not limited to the above, in the respective configuration examples shown in FIGS. 3 to 10, the print image may be formed on the outer circumferential surface 10A of the can body 10 by using the inkjet heads 11 to eject thermosetting ink to the outer circumferential surface 10A.

In this case, a heat source is installed in place of the light irradiation part 750 in the respective configuration examples shown in FIGS. 3 to 10.

In this case, the print image formed on the outer circumferential surface 10A of the can body 10 is cured by heat from the heat source.

In addition, in this case, the heat from the heat source toward the inkjet heads 11 is reduced by the can body 10 located between the heat source and the inkjet heads 11, or the shielding member 400 located between the heat source and the inkjet heads 11.

Consequently, it is less likely that defects such as clogging caused by the cured ink occur in the inkjet heads 11.

In addition, in the above, the print image was formed on the can body 10 using the inkjet heads 11; however, not limited to the inkjet heads 11, the print image may be formed by plate printing methods such as relief printing.

In other words, the printing method to perform printing on the can body 10 is not limited to the printing method using the inkjet head printing system, and the printing method using the plate printing method may be used.

In this case, installation of the light irradiation part 750 or the heat source on the opposite side of the printing unit across the can body 10 also suppresses curing of ink in the printing unit.

Moreover, also in this case, if any of the shielding members 400 shown in the above FIGS. 4 to 8 and 10 is installed, the light or heat toward the printing unit can be reduced, and thereby curing of ink in the printing unit is suppressed.

### REFERENCE SIGNS LIST

10 Can body
10A Outer circumferential surface
10E Facing portion
10F Opposite portion
11 Inkjet head
400 Shielding member
410 Light passing portion
421 First shielding member
422 Second shielding member
423 Gap
500 Printing apparatus
600 Moving mechanism
610 Shielding position
620 Out-of-route position
750 Light irradiation part
750A Light source
G Axial center

1. A printing apparatus comprising:
a printing unit disposed at a position facing an outer circumferential surface of a can body to perform printing on the outer circumferential surface of the can body that is rotating; and
a curing unit disposed on a side opposite to a side on which the printing unit is installed across the can body to cure a print image formed on the outer circumferential surface by the printing unit.

2. The printing apparatus according to claim 1, wherein
the printing unit performs printing on the outer circumferential surface using an inkjet head, and
the curing unit is disposed on a side opposite to a side on which the inkjet head is installed across the can body.

3. The printing apparatus according to claim 1, wherein
the printing unit performs printing on the outer circumferential surface from above the can body, and
the curing unit performs curing of the print image from below the can body.

4. The printing apparatus according to claim 1, wherein
the printing unit performs printing on the outer circumferential surface using photo-curable ink to form the print image, and
the curing unit irradiates the outer circumferential surface with light to cure the print image.

5. The printing apparatus according to claim 1, wherein
the curing unit cures the print image formed on the outer circumferential surface by the printing unit using light or heat, and
the printing apparatus further comprises a shielding member shielding the light or heat from the curing unit to the printing unit.

6. The printing apparatus according to claim 5, wherein the shielding member includes a portion for passing light or heat from the curing unit to the outer circumferential surface.

7. The printing apparatus according to claim 6, wherein the portion for passing is configured with an opening or a cutout formed in the shielding member.

8. The printing apparatus according to claim 6, wherein
the printing unit performs printing on the outer circumferential surface using photo-curable ink, and
the curing unit turns on a light source to irradiate the outer circumferential surface with light through the portion for passing, and turns off the light source or reduces output of the light source when the can body does not exist at a position facing the portion for passing.

9. The printing apparatus according to claim 5, wherein
the shielding member comprises a plurality of shielding members, and
a gap is provided between one of the plurality of shielding members and another to allow the light or heat from the curing unit to head for the outer circumferential surface.

10. The printing apparatus according to claim 9, wherein
the printing unit performs printing on the outer circumferential surface using photo-curable ink, and
the curing unit turns on a light source to irradiate the outer circumferential surface with light through the gap, and turns off the light source or reduces output of the light source when the can body does not exist at a position facing the gap.

11. The printing apparatus according to claim 5, wherein
the can body is cylindrically formed and has an axial center, and
the shielding member is disposed closer to the printing unit than a facing portion of the outer circumferential surface of the can body facing the curing unit, and is disposed closer to the curing unit than an opposite portion of the outer circumferential surface located on a side opposite to the facing portion across the axial center.

12. A printing apparatus comprising:
a printing unit disposed at a position facing an outer circumferential surface of a can body to perform printing on the outer circumferential surface of the can body that is rotating;
a curing unit disposed at a position facing the outer circumferential surface of the can body to cure a print image formed on the outer circumferential surface by the printing unit by using light or heat; and
a shielding member shielding the light or heat from the curing unit to the printing unit.

13. The printing apparatus according to claim 12, further comprising:
a mover unit that moves the shielding member.

14. The printing apparatus according to claim 13, wherein
at least two positions, which include a shielding position shielding the light or heat and located on a moving route of the can body, and an out-of-route position deviated from the moving route, are set, and
the mover unit moves the shielding member from one of the shielding position and the out-of-route position to the other, and moves the shielding member from the other to the one.

15. The printing apparatus according to claim 2, wherein
the printing unit performs printing on the outer circumferential surface from above the can body, and
the curing unit performs curing of the print image from below the can body.
